(19) United States
(12) Patent Application Publication
(10) Pub. No.: US 2022/0278471 A1
(43) Pub. Date: Sep. 1, 2022

(54) ELECTRICAL PLUGS WITH CONNECTORS

(71) Applicant: Hewlett-Packard Development Company, L.P., Spring, TX (US)

(72) Inventors: Paul Lalinde, Spring, TX (US); Christopher Rijken, Spring, TX (US); Robert James Kelley, Spring, TX (US); Jerome Arnaud Antoine Bove, Taipei City (TW)

(73) Assignee: Hewlett-Packard Development Company, L.P., Spring, TX (US)

(21) Appl. No.: 17/631,633

(22) PCT Filed: Sep. 30, 2019
(86) PCT No.: PCT/US2019/053754

§ 371 Date: Jan. 31, 2022

(51) Int. Cl. H01R 13/11; H01R 24/22; H01R 43/16

(52) U.S. Cl. CPC H01R 13/113; H01R 24/22; H01R 43/16; H01R 2103/00

(57) ABSTRACT

In an example, an electrical plug may include an electrical conductor and a plug body. Further, the electrical plug may include a connector disposed within the plug body. The connector may include a contact portion and a cable portion disposed alongside the contact portion. The cable portion may be attached to the electrical conductor.

### BACKGROUND

Electronic devices, including computing devices, may use electricity to power its components and carry out its functions. In some implementations, electronic devices may be mobile and operate using a battery. In other situations, electronic devices may use a power cable to draw its operating power from an external power source and use a power supply to manage the amount of power sent to or drawn by the device components.

### BRIEF DESCRIPTION OF THE DRAWINGS

FIG. 1A is a perspective view of an example electrical plug.

FIG. 1B is a perspective cutaway view of an example electrical plug.

FIG. 1C is a perspective view of an example connector of an example electrical plug.

FIG. 2A is a schematic view of an example alternating current (AC) power cable having an example electrical plug.

FIG. 2B is an exploded view of the example electrical plug of FIG. 2A.

FIG. 3A is a perspective view of an example electronic device.

FIG. 3B is a perspective view of an example electronic device.

FIG. 3C is a cross-sectional view of an electronic device taken along view line 3C-3C of FIG. 3B.

FIG. 4A is a perspective view of an example connector.

FIG. 4B is a front and side view of an example connector.

FIG. 4C is a perspective view of an example connector.

### DETAILED DESCRIPTION

Electronic devices, including computing devices, may include different components which may operate with or use power to carry out their functions. In some situations, the electronic device may be a mobile device and may include a battery to power the device and its constituent components when not connected to a power source. In other situations, the electronic device may not be meant to be a mobile device and may be connected to an external power source in order to power the device and its constituent components.

In both situations, electronic devices may use a power cable to connect to an external power source either consistently for the device's function, or intermittently in order to charge a battery for the device. In either case, a power cable may include a power plug to engage with an external source of power, another power plug to engage with the electronic device, or a power supply thereof, and a conductor extending between the power plugs such that the power cable can transfer power from the power source to the electronic device. In some implementations, the power plug that engages with the electronic device may plug into a receptacle disposed on an exterior portion of the electronic device. This engagement, in some implementations, may appear bulky, large, or otherwise have an undesirable appearance or an appearance that detracts from the aesthetic or industrial design of the electronic device.

In some situations, the plug that engages with the electronic device may have an undesirable appearance when plugged into the electronic device because of the size of the power plug. The power plug may have a specific length or size to accommodate connections between the conductor of the power cable and a connector in the power plug that engages with a pin of the electronic device to transfer power. Such connections are robust in order to reliably provide power between the conductor and the connector.

In some situations, it may be desirable to provide an electrical plug that is of a relatively smaller size and/or structure than previous or existing plugs such that an engagement between the power plug and an electronic device may be more subtle, flush, or overall aesthetically pleasing. Accordingly, it may be desirable for a connection between the conductor of a power cable and a connector within the power plug to have a relatively small connection or structure so that the overall size of the power plug may be reduced to achieve the desired aesthetically pleasing result.

Implementations of the present disclosure provide electrical plugs with connectors that have a smaller-sized or more compact connection with a corresponding conductor. Thus, example electrical plugs described herein may be able to provide a more compact, flush, or aesthetically pleasing engagement with an electronic device, or a receptacle thereupon, with which the electrical plug is to be used.

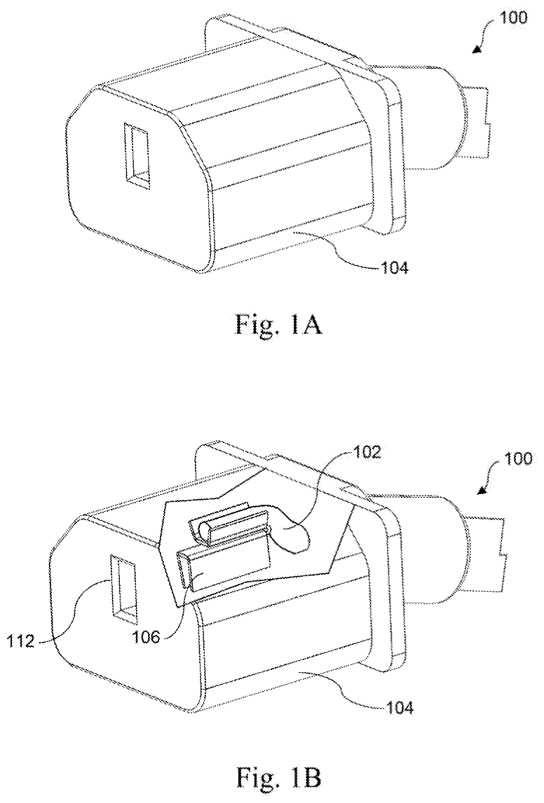

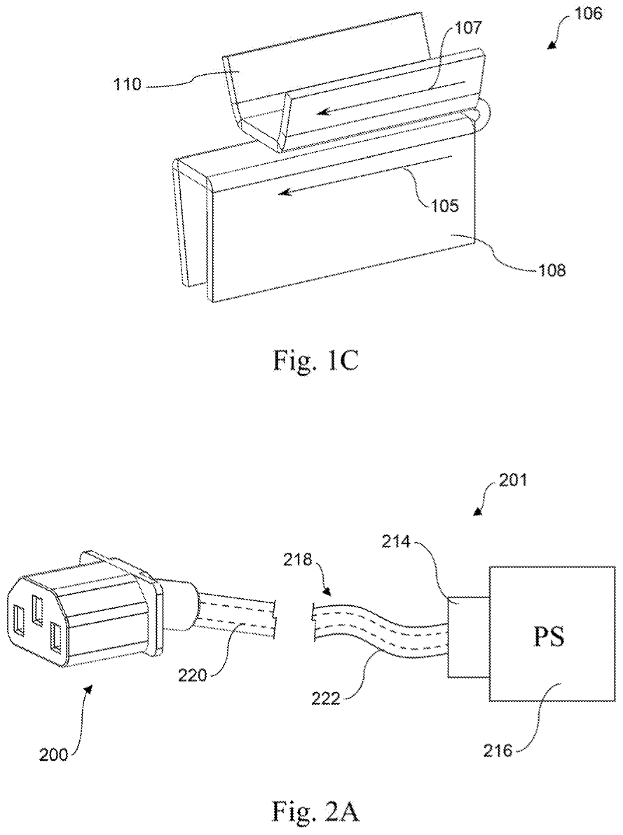

Referring now to FIGS. 1A-1B, a perspective view and a perspective cutaway view of an example electrical plug 100 are illustrated. Electrical plug 100 may include an electrical conductor 102 and a plug body 104. Further, the electrical plug 100 may include a connector 106. Referring additionally to FIG. 1C, a perspective view of the example connector 106 is illustrated. Connector 106 may include a contact portion 108 and a cable portion 110 disposed alongside the contact portion 108. The cable portion 110 may be attached to the electrical conductor 102.

The electrical conductor 102 may be a cable, wire, trace, or some other type of electrically-conductive element. Further, in some examples, the electrical conductor 102 may be enclosed in an insulator such as a sheath. The electrical conductor 102 may extend into and be disposed within the plug body 104, at least partially.

The plug body 104 may mechanically support the connector 106 and the electrical conductor 102. In some implementations, the plug body 104 may be sized and structured to mechanically engage with a complementary power receptacle. In some examples, the plug body 104 may include a pin opening 112 to receive and engage with a complementary pin from a complementary receptacle. In further implementations, the electrical plug 100, or the plug body 104 thereof, conform to an industry standard, e.g., International Electrotechnical Commission (IEC) 60320 standard for appliance couplers. In other implementations, the plug body 104 may conform to another industry standard.

The connector 106 may include a contact portion 108 and a cable portion 110 disposed alongside the contact portion 108, as described above. In this context, running alongside may refer to the connector portion 108 and the cable portion 110 being disposed alongside one another, e.g., along directions 105 and 107, and/or directly adjacent to one another in another manner. Further, the connector 106 may be constructed in a unitary manner in some examples such that the contact portion 108 and the cable portion 110 are in electrical communication and/or are electrically conductive to one another. In some examples, the connector 106 may be formed of stamped and/or bent sheet steel.

The contact portion 108 may removably mechanically and electrically engage with the complementary pin of the complementary receptacle of an electronic device. Further, the cable portion 110 may be attached to the electrical conductor in an operable manner such that electric current and/or signals may be transferred between the connector 106 and the electrical conductor 102. Thus, when the connector portion 108 is engaged with a complementary pin, electrical communication may occur between the complementary pin and the electrical conductor 102. Stated differently, the connector 106 may transfer an electrical signal or current from the electrical conductor 102 to the complementary pin. In some examples, the electrical conductor 102 may be soldered or brazed on to the cable portion 110 of the connector 106. In other examples, the electrical conductor 102 may be attached to the cable portion 110 in other ways, e.g., with a fastener.

The contact portion 108 may engage with the complementary pin directly adjacent to the attachment of the electrical conductor 102 and the cable portion 110. The cable portion 110 may extend along and be disposed alongside the contact portion 108 so as to enable the connector portion 108 and the cable portion 110 to be next to each other when each is engaged with the complementary pin and the electrical conductor 102, respectively. Thus, the total length of the connector 106 (e.g., along either of direction 105 or 107) may be shorter relative to a connector where the two portions are not disposed adjacent to one another. Accordingly, the length of the entire electrical plug 100 may be shorter relative to an electrical plug that has a different type of connector.

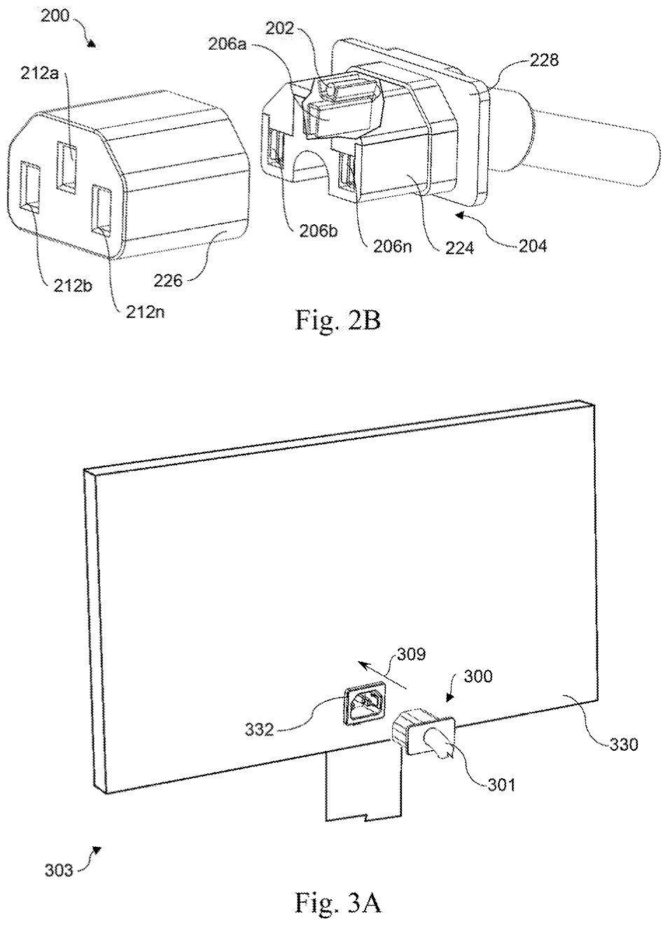

Referring now to FIG. 2A, a schematic view of an example alternating current (AC) power cable 201 having an example electrical plug 200 is illustrated. Example electrical plug 200 may be similar to example electrical plug 100, described above. Further, the similarly-named elements of example electrical plug 200 may be similar in function and/or structure to the respective elements of example electrical plug 100, as they are described above.

Note, while described herein as an AC power cable, such description is only meant to be an example, and other types of cables carrying electrical signals are also contemplated.

The AC power cable 201 may include a power plug 214 to removably engage with a power source 216. The power source 216 may be any source of alternating-current (AC) power, e.g., a wall outlet. The AC power cable 201 may further include a cable assembly 218 attached to the power plug 214. The cable assembly 218 may include an electrical conductor or plurality 220 of electrical conductors (e.g., electrical conductor 202). The cable assembly 218 may further include an insulator such as a sheath 222 enclosing the electrical conductor or plurality 220 of electrical conductors. In some examples, the cable assembly 218 may also include a plurality of insulators disposed within sheath 222, each of the plurality of insulators to insulate one or multiple electrical conductors of the plurality 220 of electrical conductors.

The electrical plug 200 may be disposed at an opposite end of the cable assembly 218 from the power plug 214. Thus, the cable assembly 218 may transfer current and/or electrical signals from the power source 216 (by way of power plug 214) to the electrical plug 200 and an electrical conductor 202 thereof.

Referring now to FIG. 2B, an exploded view of the example electrical plug 200 of FIG. 2A is illustrated. Electrical plug 200 may include a plurality of connectors 206a, 206b . . . 206n, hereinafter referred to collectively as connectors 206. Further, electrical plug 200 may also include a plurality of electrical conductors 202 (only one shown for clarity). Each of the plurality of electrical conductors 202 may be attached to a cable portion of a corresponding one of the plurality of connectors 206 such that each of the plurality of electrical conductors 202 is in electrical communication with a corresponding one of the plurality of connectors 206. The cable portion of each connector 206 may be disposed alongside a contact portion of the connector 206, as described above. Each of the plurality of connectors 206 is to engage with a complementary pin of an electronic device such that each connector 206 provides electrical communication between the complementary pin and the corresponding electrical conductor 202.

The electrical plug 200 may include a plug body 204 having a plug base 224. Plug base 224 may be a structural plug component onto which the connectors 206 and the electrical conductors 202 may be installed. In some implementations, the plug base may be a composite or polymer component that is pre-molded and then assembled with the plurality of connectors 206 and the corresponding electrical conductors 202. The plug body 204 may further include an overmolded portion 226 to enclose the plurality of connectors 206 and corresponding electrical conductors 202. The overmolded portion 226 may provide further structural support for the electrical plug 200, as well as provide protection from exterior contaminants and moisture for the plurality of connectors 206 and corresponding electrical conductors 202. Together, the plug base 224 and the overmolded portion 226 may form the plug body 204 and be structured so as to enable the plug body 204 to mechanically engage with a complementary power receptacle of an electronic device.

The plug body 204, or the overmolded portion 226 thereof, may include a plurality of pin openings 212a, 212b . . . 212n, hereinafter referred to collectively as pin openings 212. Each of the pin openings 212 may correspond to one of the plurality of connectors 206 and the associated electrical conductor 202. Each pin opening 212 may be sized and/or structured so as to be able to receive a complementary pin of a power receptacle of an electronic device, and allow such pin to mechanically and electrically engage with one of the plurality of connectors 206.

The plug body 204 may further have a back panel 228 to engage with an exterior surface of an electronic device when the electrical plug is engaged with a power receptacle thereof. In some implementations, the back panel 228 may be molded with either the plug base 224 or the overmolded portion 226, or in other examples may be assembled on to the electrical plug 200. In further implementations, the back panel 228 may sit flush or substantially flush with the exterior surface so as to preserve a positive aesthetic or industrial design of the electronic device. This flush manner may be accomplished by the connectors 206 being shorter than existing connectors, thereby allowing the electrical plug 200 as a whole to have a shorter length.

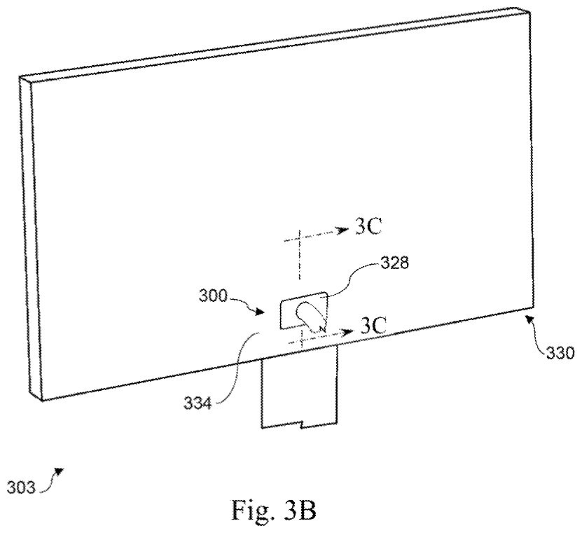

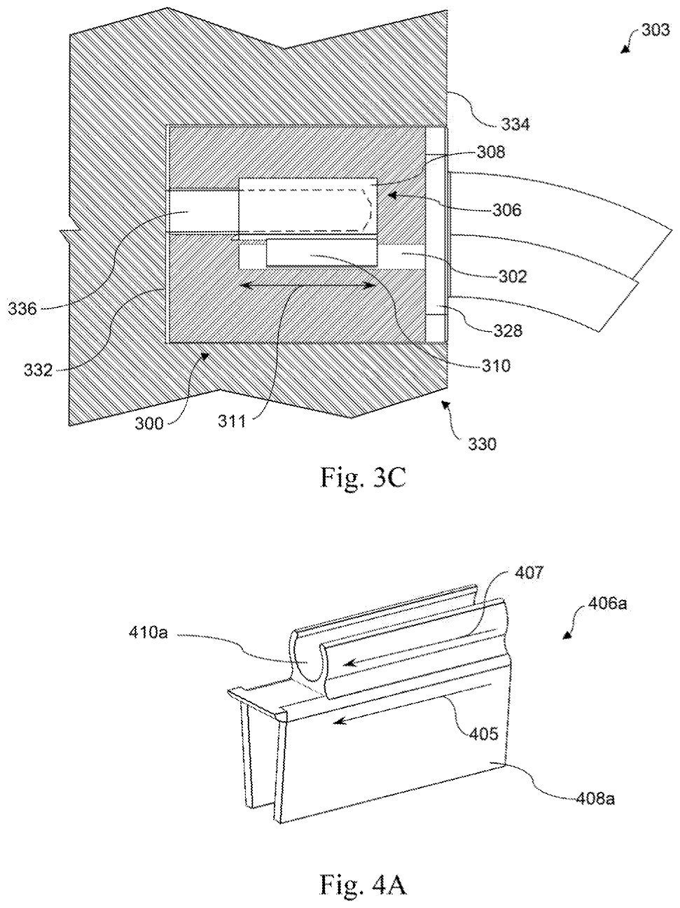

Referring now to FIG. 3A, a perspective view of an example electronic device 303 is illustrated. In some examples, the electronic device 303 may be a computing device such as a desktop personal computer (PC), a laptop or notebook PC, an all-in-one (AIO) computing device, or another type of computing device. In other examples, the electronic device 303 may be an imaging device such as a printer or copier, or another type of device such as an additive manufacturing machine, e.g., a three-dimensional (3D) printer.

In some examples, the electronic device 303 may have a housing or enclosure 330 to house and/or mechanically support components of the electronic device 303. Such components may include processors, memory, storage drives, motherboards, display panels, or other suitable components for use in the electronic device 303. The enclosure 330 may have a power receptacle 332 disposed within the enclosure 330 and having access to an exterior of the electronic device 303 through an exterior surface 334 of the enclosure 330. The power receptacle 332 may include pins or contacts for electrical communication.

The electronic device 303 may further include a power cable 301 which may provide power from a power source to the power receptacle 332 when engaged with the power receptacle 332. In order to accomplish this, the power cable 301 may include an electrical plug 300 that is structured and/or sized so as to mechanically engage with the power receptacle 332 and electrically engage with the complementary pins therein. The electrical plug 300 may engage with the power receptacle 332 by being inserted into the power receptacle 332, e.g., along direction 309. Example power cable 301 and electrical plug 300 may be similar to other example power cables and electrical plugs described above. Further, the similarly-named elements of example power cable 301 and electrical plug 300 may be similar in function and/or structure to the respective elements of other example power cables and electrical plugs, as they are described above.

Referring additionally to FIG. 3B, another perspective view of example electronic device 303 is illustrated, wherein the electrical plug 300 is fully engaged with the power receptacle 332. The electrical plug 300 has been engaged mechanically and electrically with the complementary pins of the power receptacle, as described below regarding FIG. 3C. Thus, the electronic device 303 may be in electrical communication with the power source by way of the power cable 301. In the fully inserted and/or engaged state, a back panel 328 of the electrical plug 300 may sit substantially flush with the exterior surface 334 of the enclosure 330, thereby preserving a positive aesthetic appearance and/or industrial design of the electronic device 303.

Referring now to FIG. 3C, a partial cross-sectional view of example electronic device 303 is illustrated as taken along view line 3C-3C of FIG. 3B. The electrical plug 300 may include a connector 306 having a connector portion 308 and a cable portion 310. The cable portion 310 may be attached to an electrical conductor 302, while the connector portion 308 may removably engage with a complementary pin 336 (shown partially in phantom as being partially disposed within the connector portion 308) of the power receptacle 332. The connector portion 308 and the cable portion 310 may extend alongside one another, e.g., along direction 311, so as to make the connector 306 structure more compact. In other words, the engagement of the connector portion 308 with the complementary pin 336 may overlap along direction 311 with the engagement or attachment of the cable portion 310 with the electrical conductor 302. Thus, this overlapping of engagement and compact structure of the connector 306 enables the electrical plug 300 as a whole to be shorter along direction 311. As such, the back panel 328 is able to be substantially flush with an exterior surface 334 of the enclosure 330 of the electronic device 303, thereby preserving a positive visual aesthetic of the electronic device 303 when it is engaged with the power cable 301.

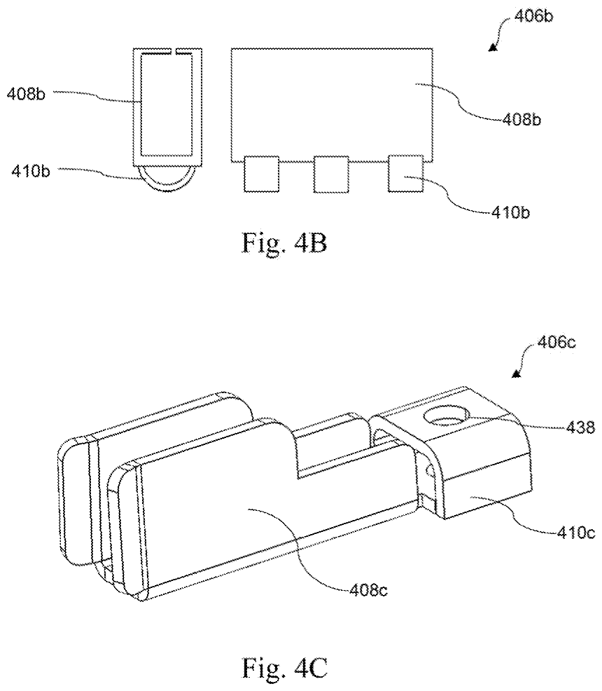

Referring now to FIGS. 4A-4C, other example connectors 406a, 406b, and 406c are illustrated. FIG. 4A illustrates a perspective view of an example connector 406a. Connector 406a may include a connector portion 408a to mechanically and electrically engage with a complementary pin of an electronic device. Connector 406a may further include a cable portion 410a disposed alongside the connector portion 408a to attach to an electrical conductor. In this context, running alongside may refer to the connector portion 408a and the cable portion 410a being disposed alongside one another, e.g., along directions 405 and 407, respectively, and/or directly adjacent to one another in another manner. In some implementations, connector 406a may be formed of extruded metallic material.

FIG. 4B illustrates a front and side views of an example connector 406b. Connector 406b may include a connector portion 408b to mechanically and electrically engage with a complementary pin of an electronic device. Connector 406b may further include a cable portion 410b disposed alongside the connector portion 408b to attach to an electrical conductor. In some implementations, connector portion 408b may have a substantially rectangular profile or cross-section, and cable portion 410b may have a substantially rounded or semi-circular profile or cross-section. In some examples, connector 406b may be constructed of bent, stamped, or otherwise formed sheet metal. Further, cable portion 410b may be formed from punching out portions of the sheet metal material, leaving rounded hoops to provide material to attach an electrical conductor to, e.g., by soldering.

FIG. 4C illustrates a perspective view of another example connector 406c. Connector 406c may include a connector portion 408c to mechanically and electrically engage with a complementary pin of an electronic device. Connector 406c may further include a cable portion 410c disposed alongside the connector portion 408c to attach to an electrical conductor. In some implementations, cable portion 410c may include an inner cavity into which the electrical conductor may be inserted. In order to accomplish this, an end of the electrical conductor may be bent around, e.g., in an L or J-shape, and then inserted into the cable portion 410c. This bending of the electrical conductor may enable the cable portion 410c to attach to the electrical conductor in a location directly adjacent to where the connector portion 408c engages with the complementary pin, thus overall reducing the length of the connector 406c. In further implementations, the cable portion 410c may include a fastener opening 438 to receive a fastener such as a screw or pin, or another type of fastener. The fastener may be used to secure the electrical conductor within the cable portion 410c.

What is claimed is:

1. An electrical plug, comprising:
an electrical conductor;
a plug body; and
a connector disposed within the plug body, comprising:
a contact portion; and
a cable portion disposed alongside the contact portion, the cable portion attached to the electrical conductor.

2. The electrical plug of claim 1, wherein the contact portion is to removably mechanically and electrically engage with a complementary pin of an electronic device adjacent to where the cable portion is attached to the electrical conductor.

3. The electrical plug of claim 2, wherein the connector is to transfer an electrical signal from the electrical conductor to the complementary pin.

4. The electrical plug of claim 1, further comprising a plurality of connectors, each engaged with a corresponding electrical conductor.

5. The electrical plug of claim 1, wherein the plug body includes an overmolded portion to enclose the plurality of connectors and corresponding electrical conductors.

6. The electrical plug of claim 1, wherein the electrical plug is part of an alternating current (AC) power cable.

7. The electrical plug of claim 1, wherein the connector is formed of stamped sheet metal.

8. The electrical plug of claim 1, wherein the connector is formed of extruded metallic material.

9. An alternating current (AC) power cable, comprising:
a power plug to engage with a power source;
a cable assembly including an electrical conductor enclosed in a sheath attached to the power plug; and
an electrical plug disposed at an opposite end of the cable assembly from the power plug and comprising:
a plug body having a plug base; and
a connector, comprising:
a contact portion to mechanically and electrically engage with a complementary pin of an electronic device; and
a cable portion attached to the electrical conductor and disposed alongside the contact portion.

10. The AC power cable of claim 9, wherein the cable portion of the connector attaches to the electrical conductor adjacent to where the contact portion engages with the complementary pin.

11. The AC power cable of claim 9, wherein the electrical plug further comprises a plurality of connectors to each engage with a complementary pin of an electronic device, each connector having a contact portion and a cable portion disposed alongside the contact portion.

12. The AC power cable of claim 11, wherein the cable assembly further includes a plurality of electrical conductors, each electrical conductor to attach to the cable portion of one of the plurality of connectors.

13. An electronic device, comprising:
an enclosure having a power receptacle disposed within the enclosure; and
a power cable having an electrical plug to engage with the power receptacle, comprising:
a plug base; and
a connector, comprising:
a contact portion to mechanically and electrically engage with a complementary pin of the power receptacle; and
a cable portion attached to an electrical conductor and disposed alongside the contact portion,
wherein the connector is to transfer an electrical signal from the electrical conductor to the complementary pin when the electrical plug is engaged with the power receptacle.

14. The electronic device of claim 13, wherein the electrical plug further includes an overmolded portion to enclose the connector, the overmolded portion and the plug base to form a plug body to mechanically engage with the power receptacle such that the connector engages with the complementary pin.

15. The electronic device of claim 13, wherein electrical plug is flush with an exterior surface of the enclosure when the electrical plug is engaged with power receptacle.
